(19) United States
(12) Patent Application Publication
(10) Pub. No.: US 2015/0370411 A1
(43) Pub. Date: Dec. 24, 2015

(54) METHOD AND ELECTRONIC DEVICE FOR CARRYING OUT EDGE SUPPRESSION AND CORRECTION

(71) Applicant: Google Technology Holdings LLC, Mountain View, CA (US)

(72) Inventors: Mitul R. Patel, Lake Zurich, IL (US); Carl G. Chin, Lisle, IL (US); Juliana Jahedi, Chicago, IL (US)

(21) Appl. No.: 14/463,101

(22) Filed: Aug. 19, 2014

Related U.S. Application Data
(60) Provisional application No. 62/015,772, filed on Jun. 23, 2014.

(51) Int. Cl. G06F 3/041; G06F 3/044

(52) U.S. Cl. CPC G06F 3/0418; G06F 3/044; G06F 2203/04112

(57) ABSTRACT

An electronic device (“the device”) includes a touchscreen display that has a centroid within a curvilinear active area of the touchscreen display. The device detects a touch at a location on the touchscreen display and determines the length of a vector between the centroid and the location. If the length is less than a predefined threshold radius, the device carries out a function in response to the touch. If the length is greater than the predefined threshold radius, the device suppresses the touch. In some implementations, the device carries out edge correction by detecting that the touch is sliding towards an edge of an active area the touchscreen display and, if the length is greater than the distance between the centroid and a predefined edge threshold, the device processes the touch as if the touch was actually closer to the predefined edge threshold.

### CROSS-REFERENCE TO RELATED APPLICATIONS

The present application claims priority to U.S. Provisional Patent Application 62/015,772, filed Jun. 23, 2014, the contents of which are incorporated herein by reference.

### TECHNICAL FIELD

The present disclosure is related generally to electronic devices having touch-screen displays and, more particularly, to a method and electronic device for carrying out edge suppression and correction.

### BACKGROUND

Popular consumer electronic devices, such as smart phones, often come equipped with a touchscreen display. Such devices often employ edge suppression, where certain types of touches detected at the edge of the display are ignored in order to screen out false inputs. These devices also commonly employ edge correction, where a touch at or near the edge of the display is “pulled in” so that the device changes the computed location of the touch to a position closer to the center.

Current techniques for carrying out edge suppression and edge correction are oriented to touchscreen display in which the effective touchscreen area (i.e., the area of the display on which the user may actually register a touch) is rectangular.

### DRAWINGS

While the appended claims set forth the features of the present techniques with particularity, these techniques, together with their objects and advantages, may be best understood from the following detailed description taken in conjunction with the accompanying drawings of which:

FIG. 1A is an exterior view of an electronic device according to an embodiment;

FIG. 1B is a diagrammatic view of the electronic device of FIG. 1A showing the various regions of the touchscreen display in an embodiment;

FIG. 1C is a side view of the electronic device of FIG. 1A and FIG. 1B;

FIG. 2 is a block diagram depicting components of an electronic device according to an embodiment; and

FIGS. 3 and 4 show flowcharts that illustrate the operation of different embodiments.

### DESCRIPTION

This disclosure is generally directed to a method and electronic device for carrying out edge suppression. According to various embodiments, the electronic device (“the device”) includes a touchscreen display whose centroid is within a curvilinear active area of the touchscreen display. The device detects a touch at a location on the touchscreen display and determines the length of a vector between the centroid and the detected location. If the length is less than a predefined threshold radius, the device carries out a function in response to the touch (e.g., changes the user interface, prompts the user for additional information, or launches an application). If the length is greater than the predefined threshold radius, the device suppresses the touch.

This disclosure is also directed to a method and electronic device for carrying out edge correction. According to various embodiments, the device includes a touchscreen display that has a centroid and an active area. The device detects a touch at a location on the touchscreen display and determines the length of a vector between the centroid and the detected location. The device also detects that the touch is sliding towards an edge of an active area the touchscreen display. If the determined length is greater than the distance between the centroid and a predefined edge threshold (i.e., a predefined distance from the edge of the active area), the device processes the touch as if the touch was actually closer to the predefined edge threshold.

According to various embodiments, the electronic device converts rectangular coordinates of an XY touch sensor array into radial measurements. Having the ability to convert XY coordinates reported by the touch sensor array into a radial measurement enhances touch tuning for edge suppression, grip suppression, water immunity, and edge accuracy in those devices having touchscreens with curvilinear edges.

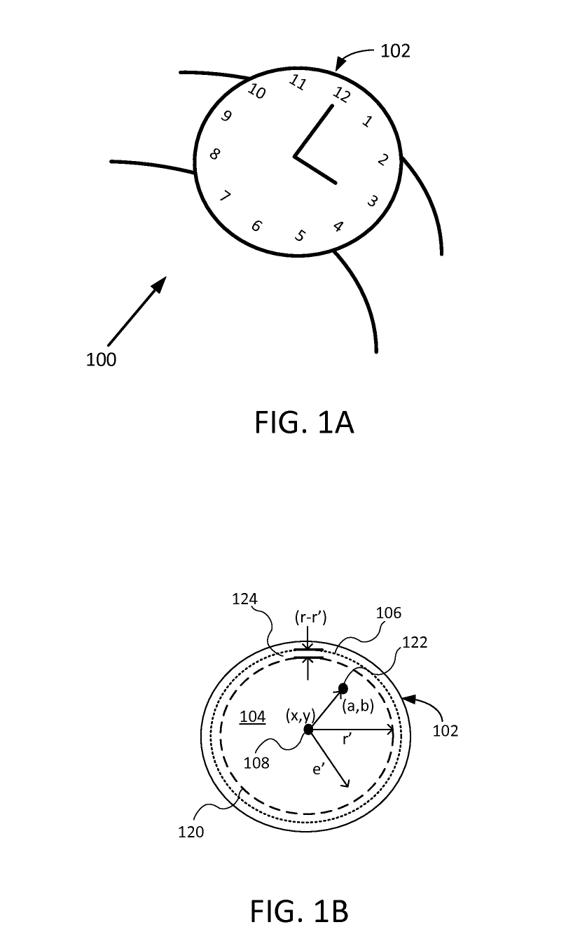

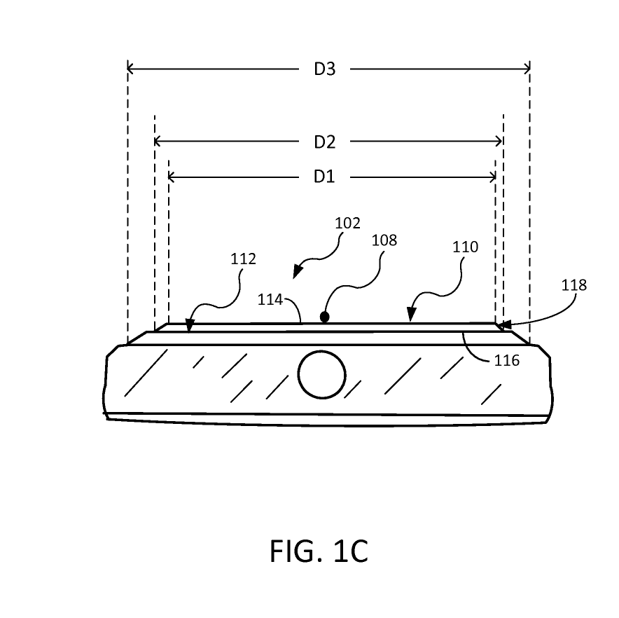

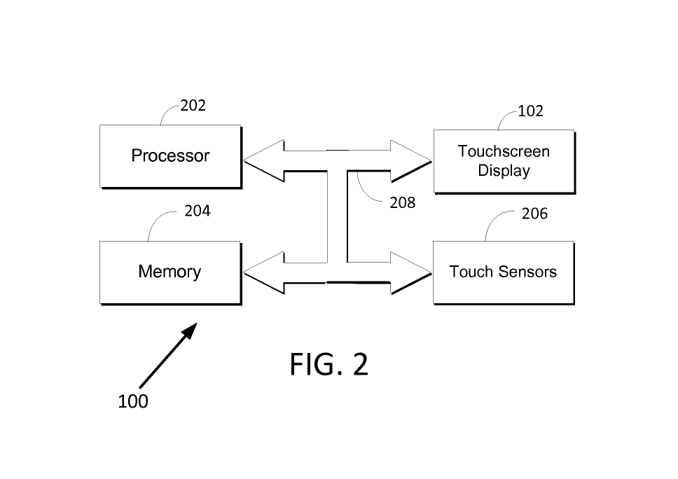

Turning to FIG. 1A, an electronic device 100 (“device 100”) according to an embodiment is shown. Although depicted as a smart watch, other possible implementations of the device 100 include a smart phone, a tablet computer, portable gaming device, or any other device that includes a curvilinear-shaped active area. The device 100 includes a touchscreen display 102. Turning to FIG. 1B, the touchscreen display 102 includes an active area 104, beneath which are one or more touch sensors. At least a portion of the active area 104 is curvilinear shaped. More specifically, at least a portion of the active area 104 has a curvilinear boundary or “edge” 106. Other shapes are possible, however, including elliptical and rounded rectangular. At or near the center of the active area 104, a centroid 108 is defined. In FIG. 1B, the active area 104 is depicted as being circular-shaped. In some embodiments, the active area 104 is a circle.

Turning to FIG. 1C, in an embodiment, the touchscreen display 102 includes a conductive layer 110 (e.g., an indium tin oxide layer) and a glass layer 112. The conductive layer 110 has a top surface 114 that is exposed to the user, and a bottom surface 116 that is attached to the glass layer 112 (e.g., via clear adhesive). Between the top surface 114 and the bottom surface 116 is a beveled portion 118. In one implementation: (1) the diameter D1 of the top surface 114, as measured through the centroid 108 is 38.74 millimeters (“mm”), with the radius being 19.37 mm. (2) The diameter D2 of the bottom surface 116 (to the edge of the conductive layer 110) is 39.74 mm, as measured through the centroid 108, with the radius being 19.87 mm. (3) The diameter D3 of the glass layer 112 as measured through the centroid 108 is 40.04 mm, with the radius being 20.02 mm. In an embodiment, the touchscreen display 102 has an X density of 8.02717665 pixels per millimeter and a Y density of 7.27226975 pixels per millimeter. The center X is at 19.87 mm from the edge 106 and the center Y at 19.87 mm from the edge 106. In one example, a touch with a reported location of X=171, Y=289 equate to an X location of 21.3026332 mm and a Y Location of 39.74 mm, with a distance from the centroid 108 being equal to a radial distance of 19.9215797 mm.

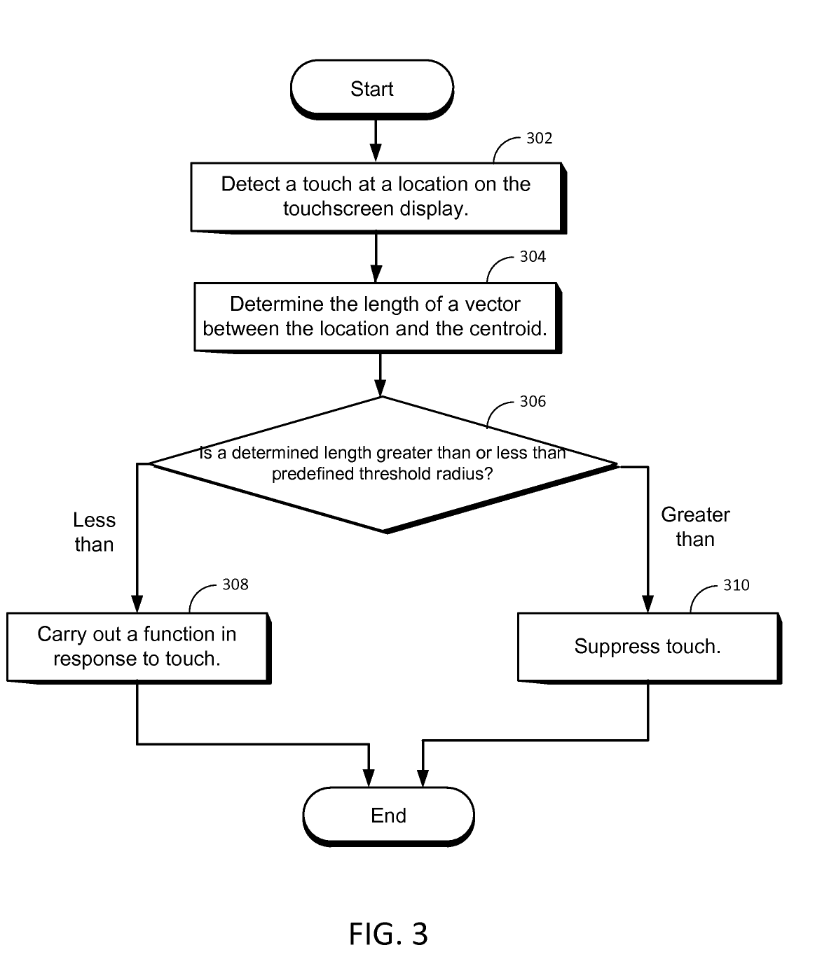

Turning to FIG. 2, the electronic device 100 in an embodiment includes a processor 202. Several components are communicatively linked to the processor 202, including the touchscreen display 102, a memory 204, and touch sensors 206 (e.g., an 8 by 9 capacitive touch sensor array located beneath and electronically coupled to the touchscreen display). The device 100 may include other components that are not depicted, such as wireless networking hardware (e.g., a WiFi chipset or a cellular baseband chipset), through which the device 100 communicates with other devices over networks such as WiFi networks or cellular networks or short range communication hardware (e.g., a Bluetooth® chipset), through which the device 100 communicates with a companion device (e.g., the device 100 is a smart watch and communicates with a paired cell phone). The elements of FIG. 2 are communicatively linked to one another via one or more data pathways 208. Possible implementations of the data pathways 208 include wires and conductive pathways on a microchip. Possible implementations of the processor 202 include a microprocessor and a controller.

The processor 202 retrieves instructions from the memory 204 and operates according to those instructions to carry out various functions, including the methods described herein. Thus, when this disclosure refers to a device carrying out an action, it is, in many embodiments, the processor 202 that actually carries out the action (in coordination with other pieces of hardware of the device as necessary).

Turning back to FIG. 1B, for the examples that follow, the centroid 108 is also referred to as location (x,y). The active area of the touchscreen display 102 has a radius r, as measured from the centroid 108 to the edge 106, and a radius r′, as measured from the centroid 108 to a predefined threshold 120 of the active area 104. It will be assumed that the user touches the touchscreen 102 at a point 122 with coordinates (a,b). Subtracting r′ from r results in a region 124 around the perimeter of the touchscreen display 102 where, in some embodiments, the device 100 applies edge suppression, such that a user would not be able to start a touch in that region.

Continuing with FIG. 1B, in some embodiments, the value e′ is a threshold for edge correction that is carried out by the device 100. In particular, when the device 100 carries out edge correction, the device 100 pulls touches (e.g., touches from a finger) that occur near the edge 106 in toward the centroid 108 (compared to where the touch actually occurred). In some embodiments, e′ is within 10 mm of the edge 106 (which is the width of an average human finger).

Generally, when a user touches a touchscreen display of an electronic device, the touch is processed where the center of his finger is sitting. However, if there is no touch sensor right underneath the edge of a touch screen display, the processor may (using standard touch sensing calculations) incorrectly calculate the touch to occur farther in towards the center. According to some embodiments, the device 100 stretches the calculated touch location back out toward the edge 106.

In an embodiment, when a user touches the touchscreen display 102, the touch sensors 206 detect the touch and report the touch to the processor 202. The processor 202 reacts as follows. Assuming that the user touches location (a,b), the processor 202 calculates the length L of a vector that originates at the centroid 108 and ends at (a,b) as follows:

L=Square root of [(x−a)²+(y−b)²]

The processor 202 compares L to r′ to make a suppression decision. In an embodiment, the processor 202 only suppresses those touches that start in the region 124. Thus, if L<r′, the processor 202 processes touch as normal (e.g., carries out a function such as changing the user interface, prompts the user for additional information, or launches an application). If L>r′, then the processor 202 suppresses the touch (e.g., ignores it or refrains from carrying out any functions based on the touch).

In another embodiment, if data from the touch sensors 206 indicates the user is touching the center region (L<r′) and slides towards the edge 106, then the processor 202 carries out the following actions depending on the value of e′: if L<e′, then the processor 202 processes the touch as it normally would (e.g., carries out a function such as changing the user interface, prompts the user for additional information, or launches an application). If L>e′, then the processor 202 applies a small stretch to bring the touch closer to the edge 106. In other words, the registers the touch so that it is closer to the edge 106 than the actual point 122 of the touch to compensate for the potential error described above.

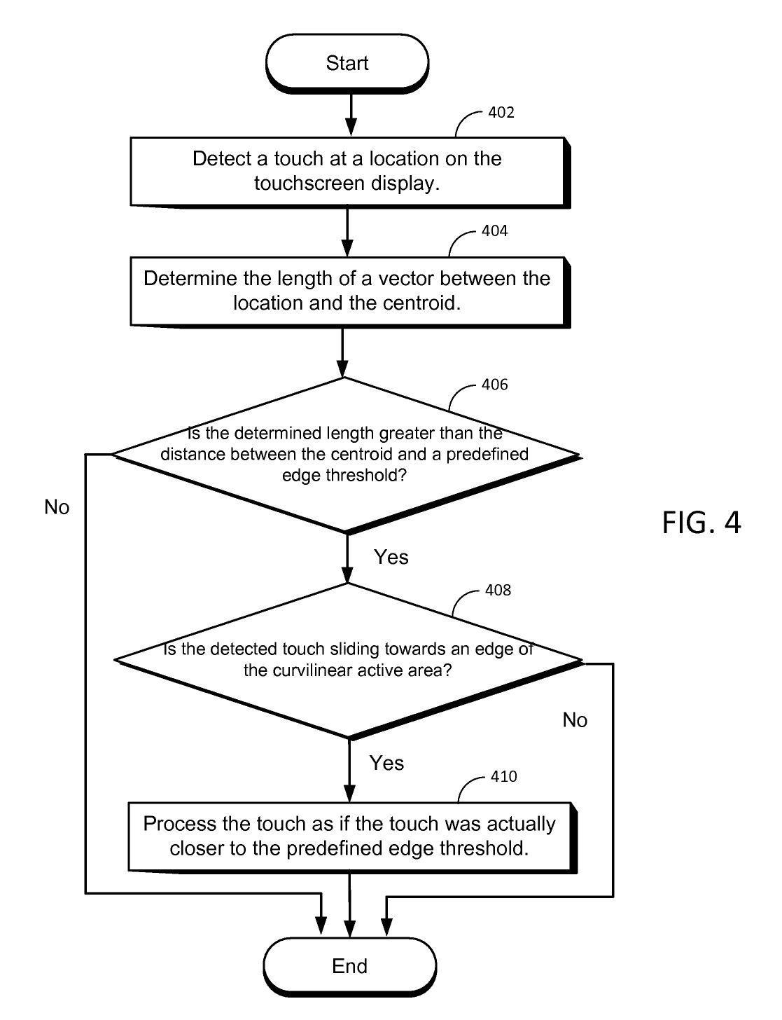

Turning to FIG. 3, operation of the electronic device 100 according to an embodiment is described. At block 302, the device 100 detects a touch at a location on the touchscreen display. For example, touch sensors 206 detect a user's touch and transmit information regarding the location to the processor 202. At block 304, the processor 202 determines the length of a vector between the location and the centroid. At block 306, the processor determines whether the length is greater or less than a predefined threshold radius. If the determined length is less than the predefined threshold radius, then the processor 202 carries out a function in response to the touch at block 308. If the determined length is greater than the predefined threshold radius, then the processor 202 suppresses the touch at block 310. In some embodiments, if the determined length is equal to the predetermined threshold, then the process moves to block 308. In other embodiments, if the determined length is equal to the predefined threshold radius, the process moves to block 310.

Turning to FIG. 4, operation of the electronic device 100 according to another embodiment is described. At block 402, the device 100 detects a touch at a location on the touchscreen display. For example, touch sensors 206 detect a user's touch and transmit information regarding the location to the processor 202. At block 404, the processor 202 determines the length of a vector between the location and the centroid. At block 406, the processor 202 determines whether the determined length is greater than the distance between the centroid and a predefined edge threshold. If the determined length is not greater than the distance between the centroid and a predefined threshold, then the process ends. If the determined length is greater than the distance between the centroid and the predefined edge threshold, then the process moves to block 408. At block 408, the processor 202 determines whether the detected touch is sliding towards an edge of the curvilinear active area of the touchscreen display. If the processor 202 determines that the touch is not sliding towards an edge of the curvilinear active area, then the process ends. If the processor 202 determines that the touch is sliding towards an edge of the curvilinear active area, then the processor 202 processes the touch as if the touch was actually closer to the predefined edge threshold.

While one or more embodiments of the have been described with reference to the figures, it will be understood by those of ordinary skill in the art that various changes in form and details may be made therein without departing from their spirit and scope of as defined by the following claims.

What is claimed is:

1. On an electronic device that includes a touchscreen display having a centroid within a curvilinear active area of the touchscreen display, a method for carrying out edge suppression, the method comprising:
detecting a touch at a location on the touchscreen display;
determining a length of a vector between the location and the centroid;
if the determined length is less than a predefined threshold radius, carrying out a function in response to the touch; and
if the determined length is greater than the predefined threshold radius, suppressing the touch.

2. The method of claim 1, wherein detecting a touch at a location on the touchscreen display comprises receiving rectangular coordinates representing the location of the touch, the method further comprising converting the rectangular coordinates to a radial coordinate.

3. The method of claim 1, wherein carrying out a function in response to the touch comprises changing a user interface of the electronic device.

4. The method of claim 1, wherein carrying out a function in response to the touch comprises prompting a user for additional information.

5. The method of claim 1, wherein carrying out a function in response to the touch comprises launching an application of the electronic device.

6. The method of claim 1, wherein determining the length of the vector comprises determining the length based on the square root of [(x−a)²+(y−b)²], wherein x is a horizontal coordinate of the centroid, y is a vertical coordinate of the centroid, a is a horizontal coordinate of the location of the touch, and b is a vertical coordinate of the location of the touch.

7. The method of claim 1, further comprising:
determining that the length is less than the predefined threshold radius;
detecting that the touch is sliding towards an edge of an active area of the touchscreen display; and
when the length is greater than a predefined edge threshold, processing the touch as if the touch was actually closer to the predefined edge threshold.

8. On an electronic device that includes a touchscreen display having a centroid within a curvilinear active area of the touchscreen display, a method for carrying out edge correction, the method comprising:
detecting a touch at a location on the touchscreen display;
determining a length of a vector between the centroid and the location; and
when the determined length is greater than a distance between the centroid and a predefined edge threshold, and when the detected touch is determined to be sliding towards an edge of the curvilinear active area, processing the touch as if the touch was actually closer to the predefined edge threshold.

9. The method of claim 8, wherein detecting a touch at a location on the touchscreen display comprises receiving rectangular coordinates representing the location of the touch, the method further comprising converting the rectangular coordinates to a radial coordinate.

10. The method of claim 8, further comprising determining the length of the vector based on a square root of [(x−a)²+(y−b)²], wherein x is a horizontal coordinate of the centroid, y is a vertical coordinate of the centroid, a is a horizontal coordinate of the location of the touch, and b is a vertical coordinate of the location of the touch.

12. An electronic device comprising:
a touchscreen display having a centroid within a curvilinear active area of the touchscreen display;
touch sensors electrically coupled to the touchscreen display, the touch sensors configured to detect a touch at a location on the touchscreen display and transmit information regarding the location; and
a processor configured to
when a length of a vector between the location and the centroid is less than a predefined threshold radius, carry out a function in response to the touch; and
when the length is greater than the predefined threshold radius, suppress the touch.

13. The electronic device of claim 12, wherein the processor is further configured to receive rectangular coordinates from the touch sensors representing the location of the touch, and convert the rectangular coordinates to a radial coordinate.

14. The electronic device of claim 12, wherein the processor is further configured to carry out a function in response to the touch by changing a user interface of the electronic device.

15. The electronic device of claim 12, wherein the processor is further configured to carry out a function in response to the touch by prompting a user for additional information.

16. The electronic device of claim 12, wherein the processor is further configured to carry out a function in response to the touch by launching an application of the electronic device.

17. The electronic device of claim 12, wherein the processor is further configured to determine the length of the vector based on the square root of [(x−a)²+(y−b)²], wherein x is a horizontal coordinate of the centroid, y is a vertical coordinate of the centroid, a is a horizontal coordinate of the location of the touch, and b is a vertical coordinate of the location of the touch.

18. The electronic device of claim 12, wherein the processor is further configured to:
determine that the length is less than the predefined threshold radius;
detect that the touch is sliding towards an edge of an active area of the touchscreen display; and
if the length is greater than a predefined edge threshold, then process the touch as if the touch was actually closer to the predefined edge threshold.
